(19) United States
(12) Patent Application Publication
(10) Pub. No.: US 2026/0037056 A1
(43) Pub. Date: Feb. 5, 2026

(54) EXTENDED REALITY SYNCHRONIZATION METHOD AND SYSTEM BASED ON USER VIEWPORT

(71) Applicant: KOREA INSTITUTE OF SCIENCE & TECHNOLOGY INFORMATION, Daejeon (KR)

(72) Inventors: Hee Jin JANG, Daejeon (KR); Min Ah KIM, Daejeon (KR); Kum Won CHO, Daejeon (KR); Myeong Jin LEE, Daejeon (KR)

(73) Assignee: KOREA INSTITUTE OF SCIENCE & TECHNOLOGY INFORMATION, Daejeon (KR)

(21) Appl. No.: 19/359,040

(22) Filed: Oct. 15, 2025

Related U.S. Application Data
(63) Continuation of application No. PCT/KR2024/096634, filed on Nov. 28, 2024.

(30) Foreign Application Priority Data
Nov. 28, 2023 (KR) 10-2023-0168576

(51) Int. Cl. G06F 3/01; H04L 67/131

(52) U.S. Cl. CPC G06F 3/011; H04L 67/131

(57) ABSTRACT

An extended reality synchronization method including: receiving spatial orientation information of a user in an extended reality space from a plurality of user terminals; determining viewport regions of the user terminals in the extended reality space based on the spatial orientation information; specifying and maintaining a synchronization group associated with each virtual object observed in the viewport regions; receiving object information and state information of a virtual object included in the synchronization group from at least one user terminal; identifying the synchronization group to which the at least one user terminal belongs based on the object information; and transmitting the state information to other user terminal included in the synchronization group.

### TECHNICAL FIELD

The present invention relates to an extended reality synchronization method and system based on a user viewport.

### BACKGROUND

Recently, interest in extended reality, which encompasses virtual reality (VR), augmented reality (AR), and mixed reality (MR), is increasing, and accordingly, contents that provide an extended reality space for various purposes are being developed.

In particular, along with the advancement of performance of a central processing unit (CPU) and a graphic processing unit (GPU), an amount of computation for rendering objects disposed in the extended reality space is also increasing. Therefore, a network load for synchronizing a state change of an object to each of a plurality of user terminals connected to the extended reality space is also increasing.

In this regard, conventionally, a state synchronization and a remote procedure call method have been used as synchronization methods. First, the state synchronization method is a method of performing synchronization by delivering a state of a corresponding object to another user terminal when a state of a specific object disposed in the extended reality space is changed, and the remote procedure call method is a method of performing synchronization by calling a specific function implemented in the extended reality space from each user terminal, and a series of functions are called to process complex interactions.

### SUMMARY

The present invention relates to an extended reality synchronization method and system for synchronizing a state of an object recognized in a viewport of a user terminal.

To solve the aforementioned object, there is provided an extended reality synchronization method, according to the present invention. The extended reality synchronization method may include: receiving spatial orientation information of a user in an extended reality space from a plurality of user terminals; determining viewport regions of the user terminals in the extended reality space based on the spatial orientation information; specifying and maintaining a synchronization group associated with each virtual object observed in the viewport regions; receiving object information and state information of a virtual object included in the synchronization group from at least one user terminal; identifying the synchronization group to which the at least one user terminal belongs based on the object information; and transmitting the state information to other user terminal included in the synchronization group.

In addition, there is provided an extended reality synchronization system, according to the present invention. The extended reality synchronization system may include: a communication unit configured to receive spatial orientation information of a user in an extended reality space from a plurality of user terminals; and a control unit configured to determine viewport regions of the user terminals in the extended reality space based on the spatial orientation information, and maintain a synchronization group associated with each virtual object observed in the viewport regions, wherein the communication unit is configured to receive object information and state information of a virtual object included in the synchronization group from at least one user terminal, and wherein the control unit is configured to identify the synchronization group to which the at least one user terminal belongs based on the object information, and transmit the state information to other user terminal included in the synchronization group.

In addition, there is provided a program executed by one or more processes in an electronic device and stored in a computer-readable recording medium, according to the present invention. The program may include instructions to cause the program to perform: receiving spatial orientation information of a user in an extended reality space from a plurality of user terminals; determining viewport regions of the user terminals in the extended reality space based on the spatial orientation information; specifying and maintaining a synchronization group associated with each virtual object observed in the viewport regions; receiving object information and state information of a virtual object included in the synchronization group from at least one user terminal; identifying the synchronization group to which the at least one user terminal belongs based on the object information; and transmitting the state information to other user terminal included in the synchronization group.

According to various embodiments of the present invention, an extended reality synchronization method and system may recognize an object in a viewport of a user terminal estimated based on spatial orientation information of a user, and generate a synchronization group for each object disposed in an extended reality space, thereby efficiently synchronizing a state of each object disposed in the extended reality space.

In addition, according to various embodiments of the present invention, the extended reality synchronization method and system, during a synchronization process in the extended reality space in which a plurality of user terminals are connected, may preferentially synchronize a specific user terminal based on a synchronization group, thereby reducing network traffic caused by synchronization in the extended reality space, and achieving reduction of end-to-end synchronization latency and saving of a battery of the user terminal resulting from the reduction of the network traffic.

### DESCRIPTION OF DRAWINGS

FIGS. 1 and 2 illustrate an extended reality synchronization system according to the present invention.

FIG. 3 is a flowchart of an extended reality synchronization method according to the present invention.

FIG. 4 is a flowchart of an embodiment of configuring a synchronization group.

FIG. 5 illustrates an embodiment of estimating a viewport region of a user terminal.

FIGS. 6 to 8 are an embodiment of configuring a synchronization group.

FIG. 9 is a flowchart of an embodiment of synchronizing a state of a virtual object.

FIG. 10 illustrates an embodiment in which a state of a virtual object changes.

FIGS. 11 to 12 illustrate an embodiment of synchronizing a state of a virtual object.

### DETAILED DESCRIPTION

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

In the present application, it should be understood that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

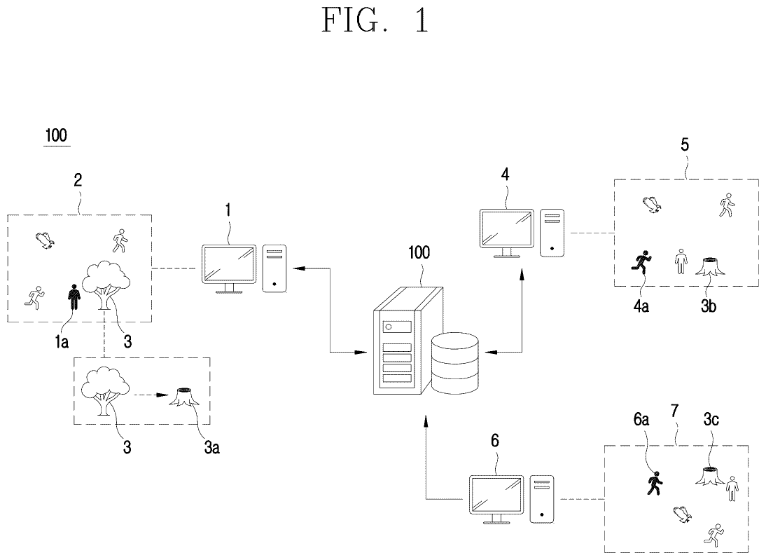

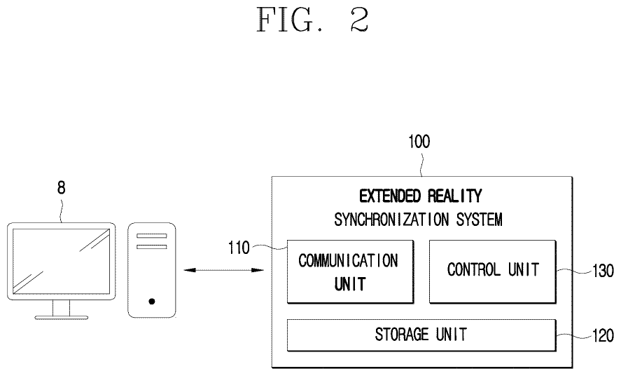

FIGS. 1 and 2 illustrate an extended reality synchronization system according to the present invention.

With reference to FIG. 1, an extended reality synchronization system 100 according to the present invention may synchronize a state of a virtual object 3 disposed in an extended reality space, to other user terminals 4 and 6, based on a viewport 2 in a user terminal 1.

Here, the extended reality space may be a mixed reality (MR) space to which virtual reality (VR) and augmented reality (AR) are applied, and may be a virtual space based on a real-world space.

However, in the present invention, the extended reality space is merely referred to as a concept that includes all of a virtual reality space, an augmented reality space, and a mixed reality space, and therefore, may be replaced with a virtual reality space, an augmented reality space, or a mixed reality space.

Therefore, the user terminal 1 may be a device that provides virtual reality, augmented reality, mixed reality, or extended reality. For example, the user terminal 1 may be a head mounted display (HMD) worn on the head, but this is merely an example, and other forms of devices may also be possible.

That is, the user terminal 1 may be referred to as a tablet, a personal computer, a smartphone, or a wearable device, and may render the extended reality space based on a pre-implemented process.

In this case, the user terminal 1 may provide the extended reality space to a user through a display provided in the user terminal 1, or may be connected, via a wireless or wired network, to a device provided to output a virtual reality space, an augmented reality space, a mixed reality space, or an extended reality space, and may provide the extended reality space rendered in the device to the user through the user terminal 1.

Accordingly, the extended reality synchronization system 100, as a server or computer device, may be implemented to provide a service according to the extended reality synchronization system 100 through the user terminal 1, and for example, the extended reality synchronization system 100 may be provided in the form of an application or software, or may be provided on a web page.

Meanwhile, the virtual object 3 may be disposed in the extended reality space, and may be implemented to perform a predetermined interaction according to a user input through the user terminal 1, or to perform a predetermined operation based on a pre-implemented algorithm with respect to the extended reality space.

For example, the virtual object 3 may be referred to as an animal, a plant, an object, or an avatar that is disposed in the extended reality space. Such the virtual object 3 may be disposed in the extended reality space by configuring arbitrary location information in the extended reality space, and based on a user input (or a pre-implemented algorithm), the previously configured location information may be changed or the virtual object 3 may be removed from the extended reality space.

Such a virtual object 3 may be matched and stored with object information. Therefore, the object information may include unique information determined for distinguishing different virtual objects 3, location information where the virtual object is disposed in the extended reality space, information related to characteristics of the virtual object (e.g., fixed type, movable type, transformable type, and interactivity, etc.), information related to one or more states predefined for the virtual object 3, and information related to a current state (or a changed state) of the virtual object 3.

In addition, the virtual object 3 may be configured with state information to represent a disposition state and an operation state of the virtual object 3 in the extended reality space.

For example, state information may refer to information related to each of a plurality of appearances with respect to a virtual object 3 that is capable of being transformed into a plurality of appearances, and may refer to location information in which the virtual object 3 is located with respect to a virtual object 3 that is capable of moving in an extended reality space, and may refer to information related to a blinking state (or, a generation state and an extinction state) of the virtual object 3 in the extended reality space.

Therefore, the virtual object 3 may be disposed in the extended reality space in a predetermined initial state according to state information, and state information may be changed to transition into another state 3a based on at least one of an interaction according to a user input or a pre-implemented algorithm.

Meanwhile, a viewport 2 may be a screen provided through an output module (e.g., a display) according to a real-time location of a user terminal in the extended reality space, and may mean a screen displayed through a display of the user terminal.

According to an embodiment, the viewport 2, with respect to a user terminal of a video-through type (e.g., a tablet), includes a real-world image scene introduced through an actual camera mounted on the user terminal, and a virtual scene (e.g., a virtual object and an avatar) augmented to the real-world image scene, and with respect to a user terminal of a see-through type (e.g., HoloLens, see-through glasses type), includes a real-world scene shown through a transmissive display and a virtual scene (e.g., a virtual object and an avatar) augmented to the real-world scene, and with respect to a user terminal of an immersive terminal type (e.g., VR, Meta Quest, etc.), may include a scene in which a virtual extended reality space is displayed regardless of camera input.

In this case, location information may include coordinates and orientation of an avatar rendered by the user terminal 1 connected to the extended reality space. That is, location information of a user may mean coordinates and orientation of an avatar rendered by the user connected to the extended reality space through the user terminal 1.

Therefore, in an embodiment, the extended reality synchronization system 100 may receive location information of a user from the user terminal 1, and based on the location information, may estimate a viewport region 2 of the user terminal 1 as a real-time screen that is visually provided to a user through a display of the user terminal at a specific location in the extended reality space.

In this regard, the extended reality space may be implemented in the form of a global contents map in the extended reality synchronization system (100). As used herein, the term “contents map” refers to a representation of knowledge and context about the global spatial state, synchronized in real time, which stores and manages spatial coordinates, orientation, and state information of virtual objects and avatars in the extended reality space. That is, the extended reality space may be implemented such that coordinates (e.g., location information) for each point are determined based on the global contents map. In addition, the extended reality space implemented as a global contents map may include a plurality of contents maps, and in such a case, the extended reality space may be implemented such that spaces related to each of the plurality of contents maps and coordinates for specific points in each contents map are determined.

Meanwhile, synchronizing a state of the virtual object 3 may be understood as providing information related to another state 3a of the virtual object 3 changed by the user terminal 1 to other user terminals 4 and 6 connected to the same extended reality space, when the virtual object 3 is changed to another state 3a in the extended reality space by the user terminal 1, thereby providing the virtual object 3 configured in the same state to a plurality of user terminals connected to the extended reality space.

To this end, with reference to FIG. 2, the extended reality synchronization system 100 according to the present invention may include a communication unit 110, a storage unit 120, and a control unit 130.

The communication unit 110 may be connected to a user terminal 8 through a wireless or wired network. Accordingly, the communication unit 110 may receive spatial orientation information from the user terminal 8, and may receive state information related to a virtual object. The term “spatial orientation information” refers to information including user location, field of view, gaze direction information, and the like. Therefore, the spatial orientation information may also be referred to as viewpoint information.

In this case, the communication unit 110, in a process of receiving a series of information from the user terminal 8, may receive information related to the user terminal 8 (e.g., an IP address, a MAC address, and a unique identifier of a terminal, etc.).

In addition, the communication unit 110 may transmit state information related to a virtual object to the user terminal 8.

The storage unit 120 may store information and instructions necessary for operation of an extended reality synchronization system 100 according to the present invention.

For example, the storage unit 120 may store information related to an extended reality space (e.g., information related to a contents map), location information, information related to a virtual object, and state information related to a virtual object.

In addition, the storage unit 120 may store information related to the user terminal 8 connected to the extended reality space.

The control unit 130 may control overall operation of the extended reality synchronization system 100 according to the present invention.

For example, the control unit 130 may receive spatial orientation information of a user in an extended reality space from a user terminal, and based on the spatial orientation information, may identify virtual objects and maintain synchronization groups for the virtual objects.

In this case, the synchronization group may be configured to correspond to each of a plurality of virtual objects disposed in the extended reality space. That is, the synchronization group may be generated for each of a plurality of virtual objects disposed in the extended reality space, and may include one or more user terminals to synchronize state information related to a specific virtual object.

Accordingly, when the control unit 130 receives state information on a virtual object disposed in the extended reality space from a user terminal, during the existing synchronization procedures, it may identify a synchronization group for the virtual object based on the object information, and synchronize a state of the virtual object by transmitting the state information to another user terminal included in the synchronization group.

Based on the above-described configuration of the extended reality synchronization system 100, a more detailed description will be provided below regarding an extended reality synchronization method.

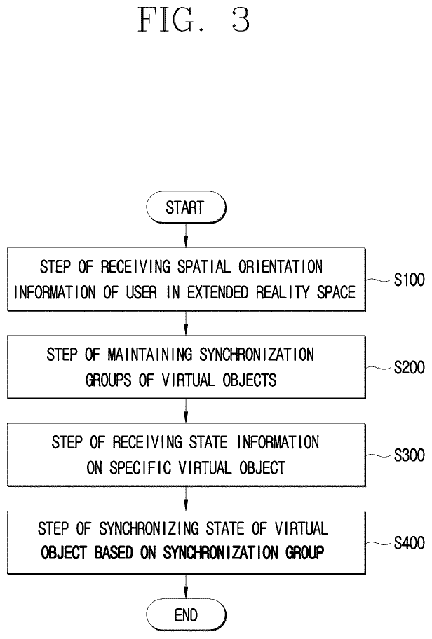

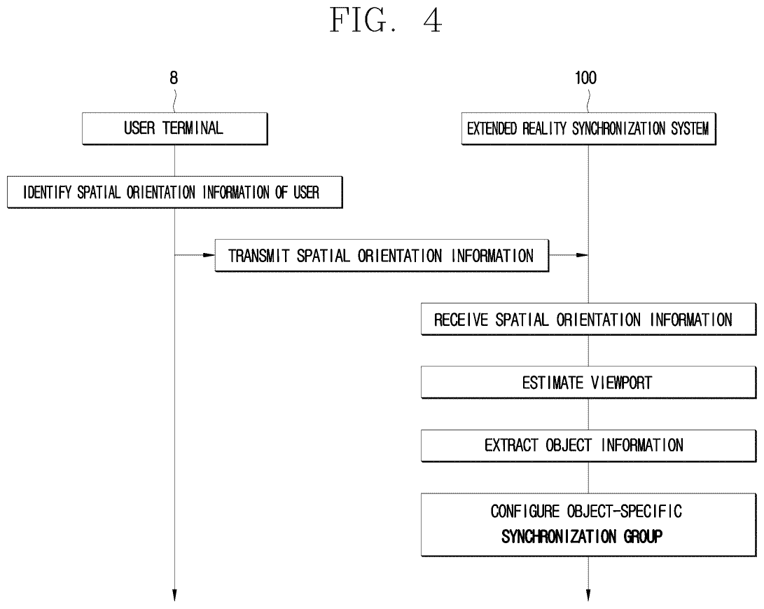

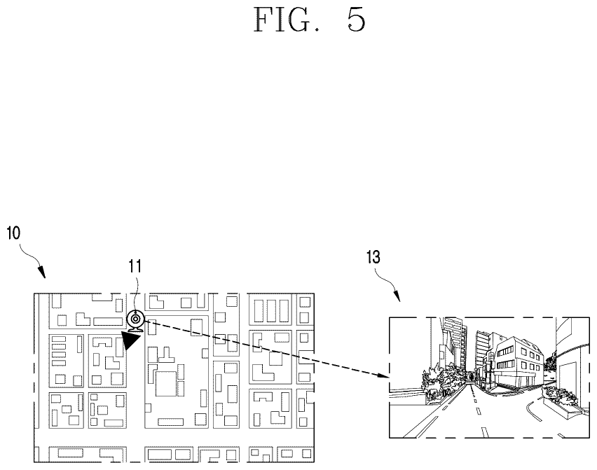

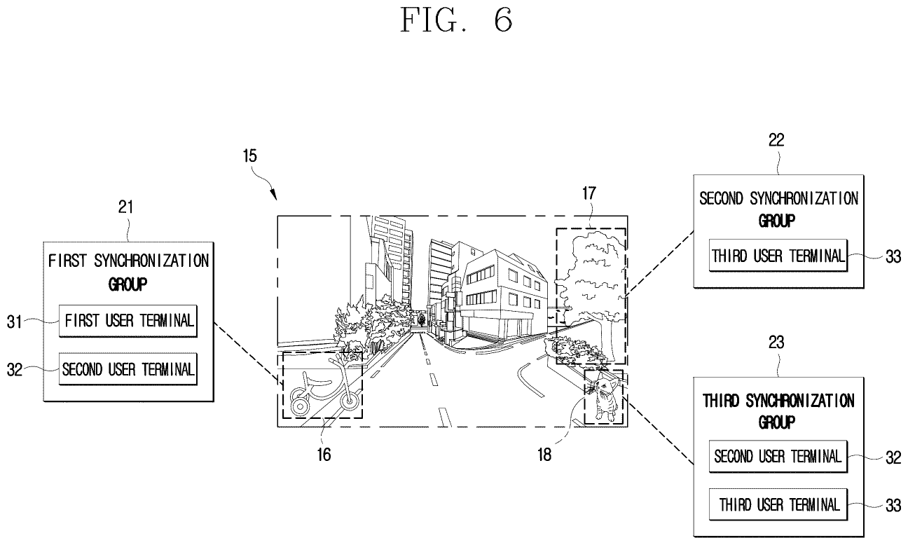

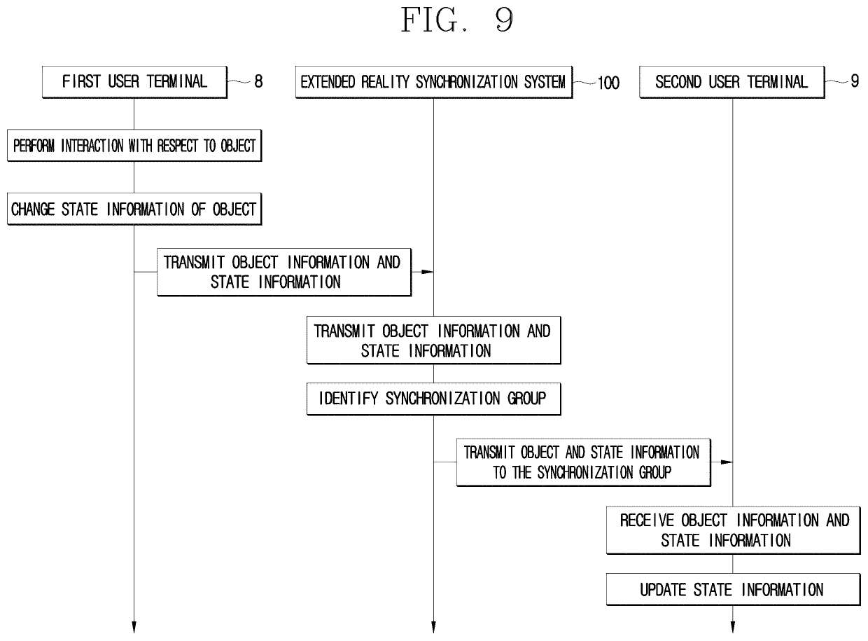

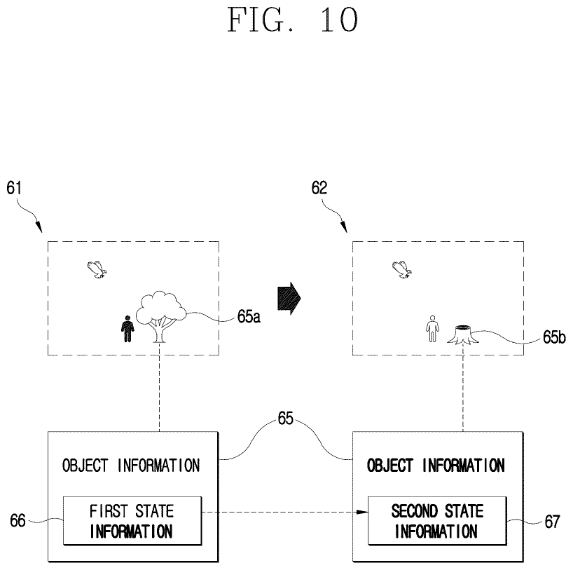

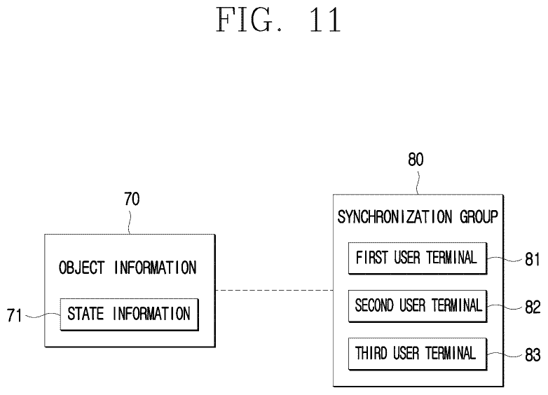

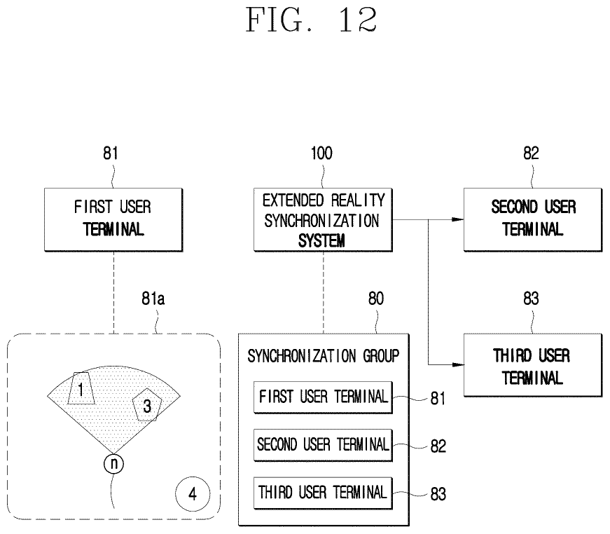

FIG. 3 is a flowchart of an extended reality synchronization method according to the present invention. FIG. 4 is a flowchart of an embodiment of configuring a synchronization group. FIG. 5 illustrates an embodiment of estimating a viewport region of a user terminal. FIGS. 6 to 8 are an embodiment of configuring a synchronization group. FIG. 9 is a flowchart of an embodiment of synchronizing a state of a virtual object. FIG. 10 illustrates an embodiment in which a state of a virtual object changes. FIGS. 11 to 12 illustrate an embodiment of synchronizing a state of a virtual object.

With reference to FIG. 3, the extended reality synchronization system 100 may receive spatial orientation information of a user in an extended reality space from a user terminal (S100), and, among a plurality of synchronization groups maintained for each virtual object disposed in the extended reality space, may add the user terminal to the synchronization group corresponding to the virtual object currently observed by the terminal (S200). The synchronization group associated with each virtual object observed in viewport regions is specified and maintained. The viewport regions of the user terminals in the extended reality space is determined based on the spatial orientation information.

With reference to FIG. 4, specifically, the user terminal 8 may identify spatial orientation information of a user in an extended reality space, and may transmit the identified spatial orientation information to the extended reality synchronization system 100 by one or more appropriate methods. For example, the location and gaze direction information of a user may be transmitted to the extended reality synchronization system 100 as included in existing synchronization messages for avatars, while the field of view information may be transmitted through a separate message from the user terminal 8 during an initial connection.

In this case, the user terminal 8, at an initial connection to the extended reality space, may transmit directional field-of-view information according to a model type. The directional field-of-view information may include field of view information in upward, downward, leftward, and rightward directions according to the model type of the user terminal 8 (e.g., transmitted once).

Accordingly, the extended reality synchronization system 100 may receive spatial orientation information of a user from the user terminal 8, and, based on the spatial orientation information, may estimate a viewport region of the extended reality space displayed on the user terminal 8, from a contents map.

With reference to FIG. 5, for example, the extended reality synchronization system 100, from a contents map 10 for the extended reality space, may specify a point 11 corresponding to spatial orientation information of the user terminal, and, based on the orientation according to the spatial orientation information of the user terminal, may estimate a viewport region 13 at the previously specified point 11. Through this, the extended reality synchronization system 100 may specify information related to a virtual object and an avatar belonging to the viewport region 13.

In addition, the extended reality synchronization system 100, by processing the previously acquired information based on information related to a viewport region of a user terminal, may estimate the viewport region of the user terminal.

In another example, the extended reality synchronization system 100, from a contents map predetermined for the extended reality space, may specify a point corresponding to location information of a user terminal, estimate a viewport region of the extended reality space from the specified point, and specify a virtual object and an avatar belonging to the estimated viewport region.

In this regard, the extended reality synchronization system 100 may receive spatial orientation information from a user terminal in real time or according to a predetermined time cycle, and may estimate a viewport region based on the received spatial orientation information.

Further, with reference back to FIG. 4, the extended reality synchronization system 100 may specify object information for an object belonging to the previously estimated viewport region, and may add the user terminal to a synchronization group corresponding to the specified object information.

Specifically, the extended reality synchronization system 100, in a viewport region (or, a scene) estimated based on spatial orientation information received from the user terminal, may recognize one or more objects, and may specify object information corresponding to the recognized objects.

Accordingly, the extended reality synchronization system 100 may identify a synchronization group matched and stored with the object information, and may add the user terminal to the identified synchronization group.

In this case, adding a user terminal to a synchronization group may be to add information related to the user terminal (e.g., a user ID logged in to the user terminal, a unique identifier of the user terminal, etc.) to the synchronization group. In case the synchronization group corresponding to the identified object information does not exist, the extended reality synchronization system 100 may generate a new synchronization group for the object.

Accordingly, the extended reality synchronization system 100 may add the user terminal to the synchronization group corresponding to the identified object information or generate a new synchronization group when the synchronization group corresponding to the identified object information does not exist.

Furthermore, the extended reality synchronization system 100 may remove the user terminal from the synchronization group corresponding to a first virtual object that is not observed in the viewport regions. The extended reality synchronization system 100 may delete the synchronization group corresponding to a second virtual object for which no observers remain.

With reference to FIG. 6, for example, when a first object 16 is recognized in a viewport region estimated based on spatial orientation information received from a first user terminal 31, the extended reality synchronization system 100 may add the first user terminal 31 to a first synchronization group 21 corresponding to the first object 16.

In addition, when the first object 16 and a third object 18 are recognized in a viewport region estimated based on spatial orientation information received from a second user terminal 32, the extended reality synchronization system 100 may add the second user terminal 32 to the first synchronization group 21 corresponding to the first object 16, and to a third synchronization group 23 corresponding to the third object 18.

In addition, when a second object 17 and the third object 18 are recognized in a viewport region estimated based on spatial orientation information received from a third user terminal 33, the extended reality synchronization system 100 may add the third user terminal 33 to a second synchronization group 22 corresponding to the second object 17, and to the third synchronization group 23 corresponding to the third object 18.

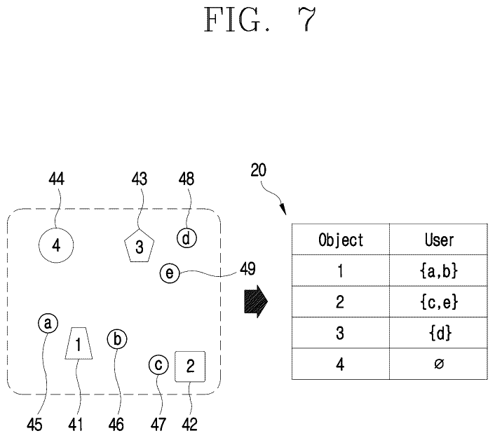

With reference to FIG. 7, in another example, the extended reality synchronization system 100 may add each of a plurality of user terminals 45, 46, 47, 48, and 49 to object-specific synchronization groups 20 based on each of a plurality of objects 41, 42, 43, and 44 recognized in viewport regions estimated respectively from the plurality of user terminals 45, 46, 47, 48, and 49.

That is, the extended reality synchronization system 100 may recognize a first object 41 in viewport regions of a first user terminal 45 and a second user terminal 46, and may add the first user terminal 45 and the second user terminal 46 to a synchronization group for the first object 41.

In addition, the extended reality synchronization system 100 may recognize a second object 42 in a viewport region of a third user terminal 47, and may add the third user terminal 47 to a synchronization group for the second object 42.

In addition, the extended reality synchronization system 100 may recognize a third object 43 in viewport regions of a fourth user terminal 48, and may add the fourth user terminal 48 to a synchronization group for the third object 43. Unlike the cases in which users gaze at adjacent objects, the system may recognize a second object 42 in the viewport region of a fifth user terminal 49, who gazes at a non-adjacent object.

In this case, when recognition of a specific object (e.g., a fourth object 44) is not possible in a viewport region of an arbitrary user terminal, the extended reality synchronization system 100 may configure a synchronization group corresponding to the specific object as an empty group.

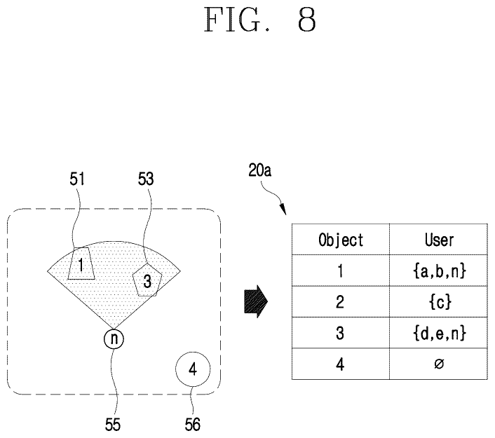

With reference to FIG. 8, in another example, when a first object 51 and a third object 53 are recognized in a viewport region estimated for a user terminal 55, the extended reality synchronization system 100 may add the user terminal 55 to a synchronization group corresponding to the first object 51, and to a synchronization group corresponding to the third object 53, among object-specific synchronization groups 20a.

Further, when an object corresponding to a synchronization group to which a user terminal is added is not recognized in a viewport region estimated for the user terminal, the extended reality synchronization system 100 may remove the user terminal from the synchronization group.

For example, the extended reality synchronization system 100, at a first point in time, when a first object is recognized in a viewport region estimated for a user terminal, may add the user terminal to a synchronization group corresponding to the first object, and at a second point in time later than the first point in time, when the first object is not recognized in the viewport region estimated for the user terminal, may remove the user terminal from the synchronization group corresponding to the first object.

In another example, the extended reality synchronization system 100, at a first point in time, when a first object is recognized in a viewport region estimated for a user terminal, may add the user terminal to a synchronization group corresponding to the first object, and at a second point in time later than the first point in time, when a second object and a third object are recognized while the first object is not recognized in the viewport region estimated for the user terminal, may remove the user terminal from the synchronization group corresponding to the first object, and may add the user terminal to a synchronization group corresponding to the second object and to a synchronization group corresponding to the third object.

In yet another example, the extended reality synchronization system 100, at a first point in time, when a specific object is recognized in a viewport region estimated for a user terminal, may add the user terminal to a synchronization group corresponding to the specific object, and at a second point in time immediately after the first point in time, when the specific object is not recognized in the viewport region estimated for the user terminal, may start counting for the user terminal added to the synchronization group corresponding to the specific object.

In such a case, the extended reality synchronization system 100, following the flow of time from the second point in time, may continue counting for the user terminal added to the synchronization group corresponding to the specific object, when the specific object is not recognized in the viewport region estimated for the user terminal, and in this case, when the specific object is recognized in the viewport region estimated for the user terminal at a specific point in time, may initialize the counted value.

In addition, the extended reality synchronization system 100, when the counted value reaches a predetermined value, may remove the user terminal from the synchronization group corresponding to the specific object.

With reference back to FIG. 3, the extended reality synchronization system 100 may receive state information on a virtual object disposed in an extended reality space from a user terminal (S300) according to existing synchronization procedures, identify a synchronization group comprising the observers of the virtual object based on the object information, and may synchronize a state of the virtual object by transmitting the state information to another user terminal included in the synchronization group (S400).

In this case, according to an embodiment, the extended reality synchronization system 100, among a plurality of user terminals connected to the extended reality space, may transmit the state information preferentially to another user terminal included in the synchronization group, rather than to another user terminal not included in the synchronization group, thereby synchronizing a state of the virtual object for the plurality of user terminals.

With reference to FIG. 9, specifically, a first user terminal 8 may perform an interaction with respect to a specific object in an extended reality space based on a user input, may change state information of the specific object according to a result of the interaction, and may transmit the changed state information and object information for the object to the extended reality synchronization system 100.

With reference to FIG. 10, for example, a user terminal may store object information 65 including first state information 66, and may render an object 65a having a tree shape according to the first state information 66 in an extended reality space 61. That is, the first state information 66 may be determined such that the object 65a having a complete tree shape is implemented.

Accordingly, the user terminal may perform an interaction with respect to the object 65a having a tree shape in the extended reality space 61 based on a user input, and according to a result of the interaction, may transform the object 65a having a tree shape into an object 65b having a tree stump shape in an extended reality space 62. In this case, second state information 67 may be determined such that the object 65b having a tree stump shape is implemented.

That is, the user terminal, by performing an interaction with respect to object information 65 having the first state information 66 based on a user input for the extended reality space 61, may change the first state information 66 to the second state information 67.

Subsequently, the user terminal, based on the change from the first state information 66 on the object 65a having a tree shape to the second state information 67, may transmit the object information 65 and the second state information 67 to the extended reality synchronization system 100.

Through this, the extended reality synchronization system 100 may receive object information and state information from the user terminal.

In another example, the user terminal may move a location of a specific object based on a user input for an extended reality space. In such a case, the user terminal may identify a location to which the specific object has been moved as state information, and may transmit object information for the specific object and the previously identified state information to the extended reality synchronization system 100.

Further, with reference back to FIG. 9, the extended reality synchronization system 100 may receive object information and state information from the user terminal 8, may identify a synchronization group corresponding to the object information, and may transmit the object information and the state information to one or more user terminals included in the identified synchronization group, thereby synchronizing the one or more user terminals included in the synchronization group.

With reference to FIG. 11, for example, the extended reality synchronization system 100 may receive object information 70 and state information 71 from a user terminal during the synchronization procedures, and may identify a synchronization group 80 corresponding to the object information 70. In this case, the synchronization group 80 may include one or more user terminals 81, 82, and 83 in which an object corresponding to the object information 70 is recognized in viewport regions of respective ones of a plurality of user terminals estimated by the extended reality synchronization system 100.

Accordingly, with reference to FIG. 12, when state information of a specific object is changed in an extended reality space 81a according to a user input, the first user terminal 81 may transmit object information and state information for the corresponding object to the extended reality synchronization system 100.

Therefore, the extended reality synchronization system 100 may receive object information and state information from the first user terminal 81, identify a synchronization group 80 corresponding to the object information, and transmit the object information and the state information to the second user terminal 82 and the third user terminal 83 included in the synchronization group 80.

Through this, the second user terminal 82 and the third user terminal 83 may receive the object information and the state information from the extended reality synchronization system 100, and among objects implemented in the extended reality space, may change the state information of an object corresponding to the previously received object information to the received state information.

As described above, the extended reality synchronization system 100, by transmitting state information changed in the first user terminal 81 to the second user terminal 82 and the third user terminal 83, may synchronize an extended reality space implemented in a plurality of user terminals.

Further, the extended reality synchronization system 100, after synchronization is completed for one or more user terminals included in a synchronization group corresponding to a specific object, may sequentially perform synchronization for another user terminal connected to the extended reality space.

Through the above-described configurations, the extended reality synchronization system 100 may recognize an object in a viewport region of a user terminal estimated based on a user's location, and generate a synchronization group for each object disposed in the extended reality space, thereby efficiently synchronizing the states of the respective objects disposed in the extended reality space.

Through the above-described configurations, the extended reality synchronization system 100 may, during a synchronization process in an extended reality space to which a plurality of user terminals are connected, preferentially synchronize a specific user terminal based on a synchronization group configured for a specific object, thereby reducing network traffic resulting from synchronization in the extended reality space, and achieving reduction of end-to-end synchronization latency and battery saving of the user terminal due to the reduced network traffic.

Further, the present invention described above may be implemented as a program executed by one or more processes in an electronic device and stored on a computer-readable recording medium.

Therefore, the present invention may be implemented as computer-readable code or instructions on a medium in which the program is recorded. That is, the various control methods according to the present invention may be provided in the form of a program, either in an integrated or individual manner.

Meanwhile, the computer-readable medium includes all kinds of recording devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy disks, and optical data storage devices.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited in type.

Meanwhile, it should be appreciated that the detailed description is interpreted as being illustrative in every sense, not restrictive. The scope of the present invention should be determined on the basis of the reasonable interpretation of the appended claims, and all of the modifications within the equivalent scope of the present invention belong to the scope of the present invention.

1. An extended reality synchronization method, comprising:
receiving spatial orientation information of a user in an extended reality space from a plurality of user terminals;
determining viewport regions of the user terminals in the extended reality space based on the spatial orientation information;
specifying and maintaining a synchronization group associated with each virtual object observed in the viewport regions;
receiving object information and state information of a virtual object included in the synchronization group from at least one user terminal;
identifying the synchronization group to which the at least one user terminal belongs based on the object information; and
transmitting the state information to other user terminal included in the synchronization group.

2. The extended reality synchronization method of claim 1, further comprising:
synchronizing the state of the virtual object for the plurality of user terminals, by transmitting the state information preferentially to the other user terminal included in the synchronization group, rather than to another user terminal not included in the synchronization group, among the plurality of user terminals connected to the extended reality space.

3. The extended reality synchronization method of claim 1, wherein the spatial orientation information includes at least one of location information, gaze information, and field of view information, and
wherein directional field-of-view information according to a model type is received from a user terminal initially being connected to the extended reality space.

4. The extended reality synchronization method of claim 3, wherein the specifying and maintaining of the synchronization group comprises:
recognizing the virtual object included in the viewport regions, and identifying the object information; and
adding the user terminal to the synchronization group corresponding to the identified object information or generating a new synchronization group when the synchronization group corresponding to the identified object information does not exist.

5. The extended reality synchronization method of claim 4, wherein the specifying and maintaining of the synchronization group further comprises:
removing the user terminal from the synchronization group corresponding to a first virtual object that is not observed in the viewport regions; and
deleting the synchronization group corresponding to a second virtual object for which no observers remain.

6. The extended reality synchronization method of claim 4, wherein the estimating of the viewport region displayed on the user terminal comprises:
specifying a point corresponding to the spatial orientation information in a contents map predetermined for the extended reality space; and
estimating a viewport region corresponding to the viewport region at the specified point based on an orientation according to the spatial orientation information.

7. The extended reality synchronization method of claim 4, wherein the estimating of the viewport region displayed on the user terminal comprises:
receiving the spatial orientation information from the user terminal according to a predetermined time cycle; and
estimating a viewport region based on the received location information.

8. The extended reality synchronization method of claim 1, wherein the synchronization group comprises:
one or more user terminals, in which an object corresponding to a specific object information is recognized in a viewport region of each of a plurality of user terminals, among the plurality of user terminals connected to the extended reality space.

9. The extended reality synchronization method of claim 1, wherein the state information represents a state of the specific virtual object changed according to a result of an interaction that is performed with respect to a specific object in the extended reality space, based on a user input in the user terminal.

10. An extended reality synchronization system, comprising:
a communication unit configured to receive spatial orientation information of a user in an extended reality space from a plurality of user terminals; and
a control unit configured to determine viewport regions of the user terminals in the extended reality space based on the spatial orientation information, and maintain a synchronization group associated with each virtual object observed in the viewport regions,
wherein the communication unit is configured to receive object information and state information of a virtual object included in the synchronization group from at least one user terminal, and
wherein the control unit is configured to identify the synchronization group to which the at least one user terminal belongs based on the object information, and
transmit the state information to other user terminal included in the synchronization group.

11. A program executed by one or more processes in an electronic device and stored in a computer-readable recording medium,
wherein the program comprises instructions to cause the program to perform:
receiving spatial orientation information of a user in an extended reality space from a plurality of user terminals;
determining viewport regions of the user terminals in the extended reality space based on the spatial orientation information;
specifying and maintaining a synchronization group associated with each virtual object observed in the viewport regions;
receiving object information and state information of a virtual object included in the synchronization group from at least one user terminal;
identifying the synchronization group to which the at least one user terminal belongs based on the object information; and
transmitting the state information to other user terminal included in the synchronization group.
